(19) United States
(12) Patent Application Publication
(10) Pub. No.: US 2016/0042670 A1
(43) Pub. Date: Feb. 11, 2016

(54) Raised/3D stickers for identification of items

(71) Applicant: Melissa Marlow Reid, Linden, VA (US)

(72) Inventor: Melissa Marlow Reid, Linden, VA (US)

(21) Appl. No.: 14/823,339

(22) Filed: Aug. 11, 2015

Related U.S. Application Data
(60) Provisional application No. 62/035,904, filed on Aug. 11, 2014.

(51) Int. Cl. G09F 3/02; G09F 3/10

(52) U.S. Cl. CPC G09F 3/02; G09F 3/10

(57) ABSTRACT

Identification stickers for personal items are waterproof, and intended for use on bottles of shampoo, body wash, conditioner, and other personal items used in the bath or shower. The waterproof stickers may also be used on vanity items such as: perfume, hairspray, or deodorant; pool/beach items such as: sunscreen, aloe, or lotion; or cleaning items such as: cleaners or poisons. The stickers enable the user, who may be visually impaired, to distinguish the personal items from each other easily. The stickers are inexpensive and may be provided in multiples on peel-and-stick sheets.

### CROSS-REFERENCE TO RELATED APPLICATIONS

This Application claims the benefit of U.S. Provisional Application No. 62/035904, filed Aug. 11, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to bathroom accessories, and in particular to identification stickers for personal items. The visually impaired are often dependent upon the assistance of others for a broad range of activities and needs. The desire to be completely independent, in as many areas of their lives as possible, is very strong. This is particularly true when bathing or engaged in other activities where complete privacy is customary. Even those with no vision problems may have a difficult time distinguishing between bottles of shampoo and conditioner is difficult, even for the fully sighted, since they are often the same size, shape, and color. Fully sighted persons may also have trouble distinguishing between items when they have water or soap in their eyes. Identification stickers for personal items, which may be affixed to bottles of shampoo or body wash and enable the user to identify them via bright colors, textures, or raised lettering, would resolve this problem.

### SUMMARY OF THE INVENTION

Accordingly, the invention is directed to three-dimensional identification stickers for personal items. The stickers are waterproof, and intended for use on bottles of shampoo, body wash, conditioner, and other personal items used in the bath or shower. The stickers may also be used to identify vanity items, pool/beach items, or cleaning products in bathrooms or kitchens. The stickers enable the user, who may be visually impaired, to distinguish the personal items from each other easily. The stickers are inexpensive and are provided in multiples on peel-and-stick sheets.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 is a front view of the first exemplary embodiment installed on a personal item, displaying the sticker 10, the Braille lettering 11, the raised lettering 12, and the personal item 13.

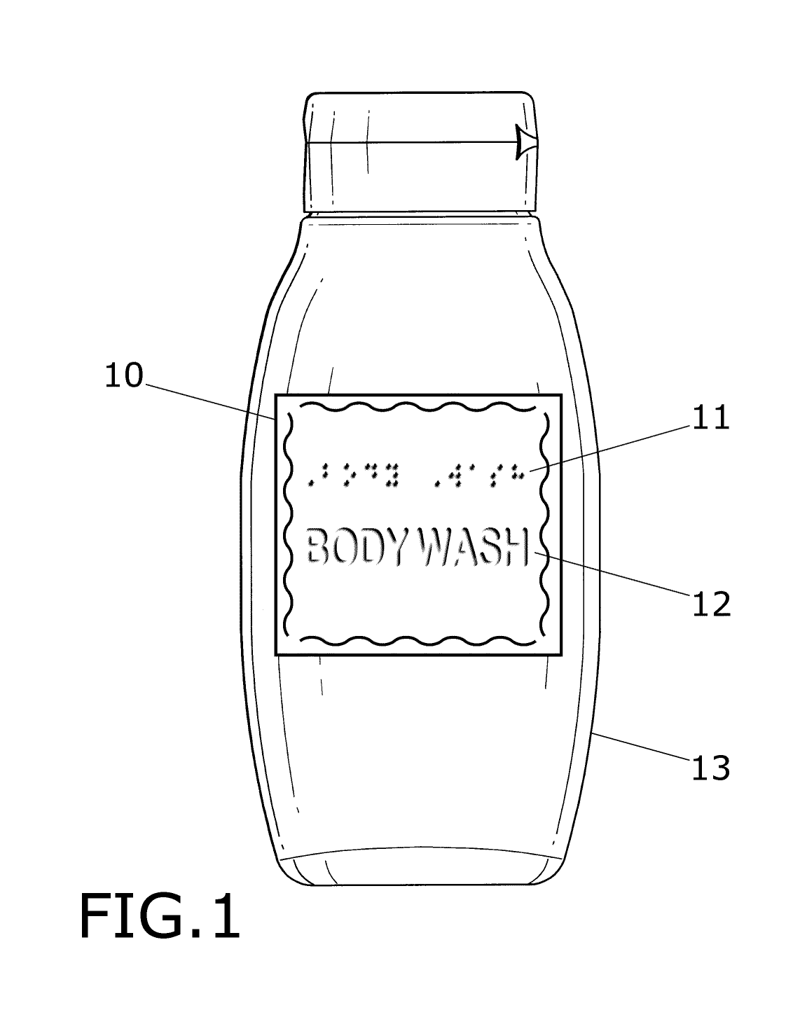

FIG. 2 is a front view of the first exemplary embodiment on a peel-and-stick sheet, displaying the stickers 10 and the peel-and-stick sheet 14.

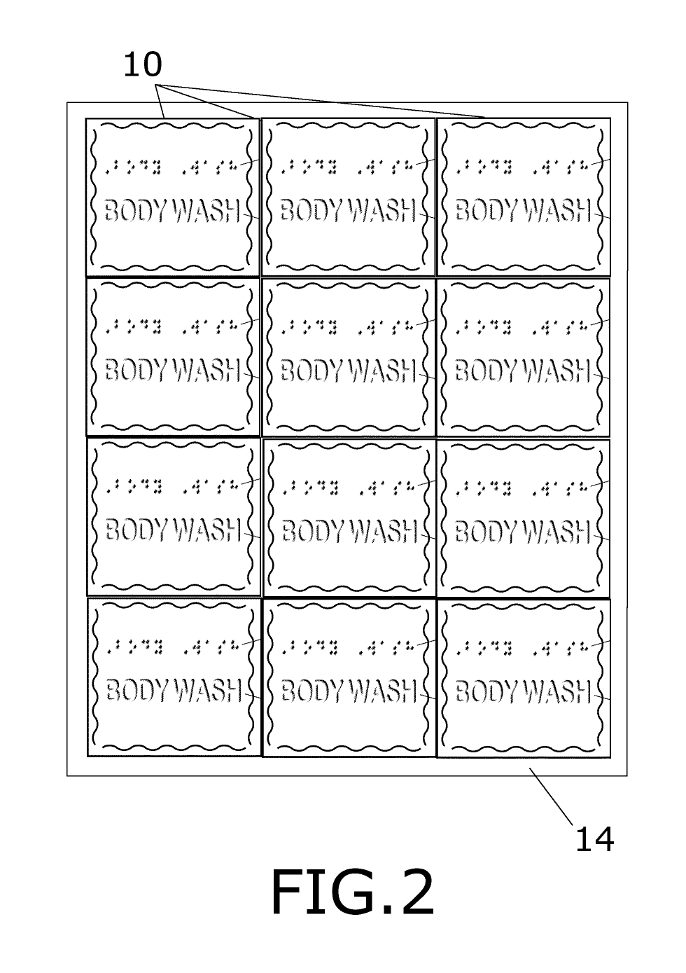

### DETAILED DESCRIPTION OF THE INVENTION

Referring now to the invention in more detail, the invention is directed to identification stickers 10 for personal items 13. The stickers 10 are waterproof, and intended for use on bottles of shampoo, body wash, conditioner, and other personal items 13 used in the bath or shower. The stickers 10 may also be used to identify vanity items, pool/beach items, or cleaning products in bathrooms or kitchens. The stickers 10 enable the user, who may be visually impaired, to distinguish the personal items 13 from each other easily. The stickers 10 are inexpensive and are provided in multiples on peel-and-stick sheets 14.

It is to be understood that while the invention is intended for use with personal items that are used in the bath or shower, this is not intended as a limitation. With suitable modification, the stickers may be used on any household items which are similar in size and shape, and therefore difficult to distinguish for the visually impaired, such as cans of vegetables or soup in a pantry or kitchen cupboard, or bottled condiments in a refrigerator, with additional importance on items such as household cleaners and other toxic chemicals which could be hazardous if mistaken. Additionally, the invention may be used on pool/beach items.

The first exemplary embodiment provides a sticker 10, which is intended to be affixed to a bottle of shampoo, body wash, conditioner, body lotion, or other personal item 13 used in the bath or shower. Each sticker 10 preferably provides Braille lettering 11 on its upper half, and raised lettering 12 in the Latin alphabet on its lower half, both identifying the contents of the bottle such as “Shampoo” or “Body Wash.” The stickers 10 are preferably provided in multiples on peel-and-stick sheets 14, and are preferably provided in mixed sets, such as two which read “Shampoo,” two which read “Conditioner,” two which read “Body Wash,” and two which read “Body Lotion.” Alternate embodiments are also contemplated which provide stickers 10 bearing different types of indicia, such as different surface textures or, for persons who may not be completely blind, brightly colored surfaces in different colors. For these users, additional pages of individual alphabet letters and numbers may be offered, to be employed in users' development of their own identification methods and systems.

To use the first exemplary embodiment, the user removes the sticker 10 from the peel-and-stick sheet 14 and affixes it to the front surface of the corresponding personal item 13.

The sticker 10 is preferably manufactured from a flexible, durable material which is waterproof, such as acetate. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. Identification stickers for personal items, comprising:
(a) a sticker;
(b) said sticker being waterproof;
(c) said sticker having a three dimensional component;

2. The identification stickers for personal items of claim 1, further comprising a sheet; said sheet being a peel and stick sheet further comprising a plurality of said stickers.

3. The identification stickers for personal items of claim 1, wherein, said three dimensional component is a tactile writing system; said tactile writing system identifying specific personal items.

4. The identification stickers for personal items of claim 2, wherein, said three dimensional component is a tactile writing system; said tactile writing system identifying specific personal items.

5. The identification stickers for personal items of claim 1, wherein, said three dimensional component is raised lettering; said raised lettering identifying specific personal items; said raised lettering being the Latin alphabet and numerals.

6. The identification stickers for personal items of claim 2, wherein, said three dimensional component is raised lettering; said raised lettering identifying specific personal items; said raised lettering being the Latin alphabet and numerals.

7. The identification stickers for personal items of claim 1, wherein, said three dimensional component is both a tactile writing system and raised lettering; said tactile writing system and raised lettering identifying specific personal items.

8. The identification stickers for personal items of claim 2, wherein, said three dimensional component is both a tactile writing system and raised lettering; said tactile writing system and raised lettering identifying specific personal items.

9. The identification stickers for personal items of claim 4, wherein said plurality of stickers identify a variety of personal items; said variety of personal items being one or more of shampoo, conditioner, body wash, body lotion, perfume, hair products, deodorant, sunscreen, aloe, lotion, cleaners, or poisons.

10. The identification stickers for personal items of claim 6, wherein said plurality of stickers identify a variety of personal items; said variety of personal items being one of shampoo, conditioner, body wash, body lotion, perfume, hair products, deodorant, sunscreen, aloe, lotion, cleaners, or poisons.

11. The identification stickers for personal items of claim 8, wherein said plurality of stickers identify a variety of personal items; said variety of personal items being one of shampoo, conditioner, body wash, body lotion, perfume, hair products, deodorant, sunscreen, aloe, lotion, cleaners, or poisons.

12. The identification stickers for personal items of claim 1, wherein, said three dimensional component is a specific surface texture; said specific surface texture identifying specific personal items.

13. The identification stickers for personal items of claim 2, wherein, said three dimensional component is a specific surface texture; said specific surface texture identifying specific personal items.

14. The identification stickers for personal items of claim 13, wherein said plurality of stickers identify a variety of personal items; said variety of personal items being one of shampoo, conditioner, body wash, body lotion, perfume, hair products, deodorant, sunscreen, aloe, lotion, cleaners, or poisons.

15. The identification stickers for personal items of claim 4, wherein said plurality of stickers indicated individual letters or numbers.

16. The identification stickers for personal items of claim 6, wherein said plurality of stickers indicated individual letters or numbers.

17. The identification stickers for personal items of claim 8, wherein said plurality of stickers indicated individual letters or numbers.

18. The identification stickers for personal items of claim 13, wherein said plurality of stickers indicated individual letters or numbers.
